(19) United States
(12) Patent Application Publication
(10) Pub. No.: US 2014/0229367 A1
(43) Pub. Date: Aug. 14, 2014

(54) APPARATUS FOR FINANCING MOBILE EQUIPMENT

(71) Applicant: KITARU INNOVATIONS INC., St. James (BB)

(72) Inventor: Kapoor Chandaria, Nairobi (KE)

(73) Assignee: KITARU INNOVATIONS INC., St. James (BB)

(21) Appl. No.: 13/765,774

(22) Filed: Feb. 13, 2013

(51) Int. Cl. G06Q 20/24

(52) U.S. Cl. CPC G06Q 20/24
USPC 705/39

(57) ABSTRACT

A system and method for payment of an item purchased using credit is presented. A system includes financial transaction detection logic and payment logic. The financial transaction detection logic detects that a financial transaction is being initiated at the purchased item. For example, the logic can be implanted in a fare payment device in a bus that was purchased with credit. The transaction logic detects each time a fare is paid to ride the bus. The repayment logic repays a portion of the purchased item (bus) when the financial transaction (fare payment) occurs. Alternatively, the financial transaction detection logic can be inside an electronic handheld device purchased on credit. The logic detects when the device is used to make a purchase or connect to a network. Each of those times, the payment logic can calculate a repayment amount to repay a portion of the handheld device and collect it.

### BACKGROUND

1. Field of Invention

The current invention relates generally to apparatus, systems and methods for financing purchases. More particularly, the apparatus, systems and methods relate to financing a purchase and paying for the purchase periodically after the purchase. Specifically, the apparatus, systems and methods provide for financing a purchase and paying for the purchase with installments each time a financial transaction is initiated with the purchased item.

2. Description of Related Art

Credit is used to finance a variety of purchases. However, creditors may often be hesitant to extend someone credit if they are not highly sure they will be repaid. Also, purchasing on credit requires that the person receiving the credit make periodic payments. This requires them to set up bookkeeping to ensure that they write a monthly check to repay their credit or set up some other accounting method of repaying their credit on a periodic basis. What is needed is a better way of paying off credit.

### SUMMARY

The preferred embodiment of the invention includes a system for payment of an item that was purchased using credit. A system includes financial transaction detection logic and payment logic. The financial transaction detection logic detects that a financial transaction is being initiated at the purchased item. For example, the logic can be implanted in a fare payment device in a bus that was purchased with credit. The transaction logic detects each time a fare is paid to ride the bus. The repayment logic then repays a portion of the credit used to purchase the purchased item (bus) when the financial transaction (fare payment) occurs. Alternatively, the financial transaction detection logic can be inside an electronic handheld device purchased on credit. The financial transaction detection logic detects when the device is used to make a purchase. Alternatively, it could detect each time the handheld device is connected to a network. Each of those times, the payment logic can calculate a repayment amount and to pay it at that time or to accumulate repayments for payment at a later time. A wide variety of purchased items can be repaid this way until they are fully paid off. When they are paid off, the automatic payments also end. This automated repayment of credit ensures creditors and lenders that they will periodically be repaid virtually automatically allowing them to more freely extend credit.

Another configuration of the preferred embodiment is a method of financing a purchase of a purchased item and repaying the borrowed funds for the purchased item at a later time. The method begins by financing or purchasing a purchased item on credit. Next, a financial transaction that is being initiated at the purchased item is detected. As discussed in more detail below, the transaction may be a person paying a fare at bus that was purchased with credit or the transaction can be connecting to a network with a handheld device that was purchased with credit or the purchasing of something else using the handheld device. A portion of the purchased item to be repaid is calculated, upon the financial transaction detection logic detecting that a financial transaction is being conducted at the purchased item. A percentage of the financial transaction can be used to determine the partial repayment amount of the purchase item.

The calculated repayment portion of the purchased item is then repaid to the entity that financed the purchase of the purchased item. The repaying can include the crediting a financial account with a payment and this can be done automatically over a network that can be at least partly a wireless network. The method can transmit a message indicating a portion of the purchased item has been repaid. The message can be transmitted to a creditor, financial institution or someone else interested in monitoring the continued payment of the purchased item. The method can also keep a running tabulation amount that is a total amount that has been repaid on the purchased item. When this tabulation amount is the same as the purchase credit or financing value used to purchase the purchased item it has been repaid. The method will then discontinue repaying a portion of the purchased item when the purchased item has been repaid.

Other configurations of the method can make payments when credit is extended from two or more entities to purchase the purchased item. In these cases, the repaying a portion of the purchased item at the time of transaction at the purchased item can include repaying a portion of the purchased item to each of the financing entities. Alternatively, the method can alternate payments to one or more of the financing entities in a round-robin fashion after each financial transaction at the purchased item. The method can also generate a receipt that a payment has been made and or it can send a message to a display associated with individual(s) or entity(s) interested in monitoring the continued payment of the purchased item.

### BRIEF DESCRIPTION OF SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a preferred embodiment of system that pays off the credit of a purchased item.

FIG. 2 illustrates an embodiment of a method for financing and paying for an item later.

Similar numbers refer to similar parts throughout the drawings.

### DETAILED DESCRIPTION

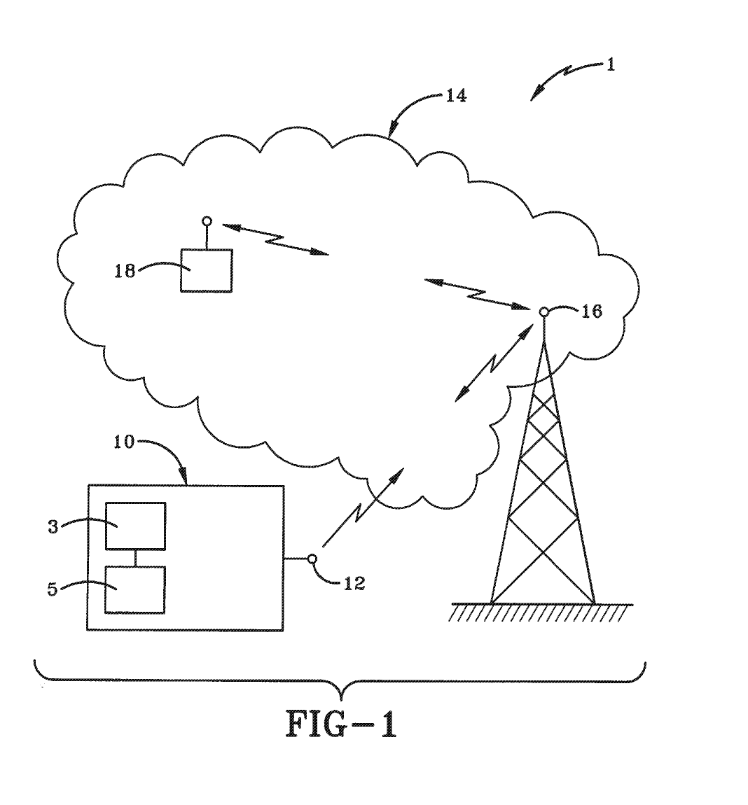

FIG. 1 illustrates the preferred embodiment of a system 1 that pays off an item that was purchased on credit or through other financing. The system 1 includes financial transaction detection logic 3 and repayment logic 5. These logics can be located anywhere but in some applications they can be included with or internal to a purchased item that is purchased on credit. This logic allows the purchased item to be used and allows for it to later be paid for in increments. For example, the financial transaction detection logic 3 and repayment logic 5 can be in a fare collection system located in a bus or another vehicle that has been purchased on credit. The financial transaction detection logic 3 can detect each time that a passenger boards the bus and begins paying their fare. The repayment logic 5 can then calculate a repayment amount that may be a percentage of the purchased fare and to repay that portion of the credit. For example, the repayment logic might prepay a fixed percent of every fare collected to the entity that financed the bus.

In another example, the financial transaction detection logic 3 and repayment logic 5 can be include inside of a handheld device 10 (or any “purchased item”) such as a laptop computer, cellular telephone, iPad and the like. The handheld device 10 can also be purchased on credit and then the financial transaction detection logic 3 can detect, for example, whenever the handheld device 10 is used to purchase something over a network and a percentage relating to the purchase price (or a fixed) fee can be repaid to the entity financing the purchase of the handheld device 10 each time an item is purchased with the handheld device 10. Alternatively, the financial transaction detection logic 3 could detect each time the handheld device is connected to a network and the repayment logic could automatically repay a portion of the financed based on each connection to a network. Alternative the financial transaction detection logic 3 and repayment logic 5 can be include inside of a kiosk that was purchased with credit or virtually any type of device that is purchased with credit and where financial transactions subsequently occur. For example, a sports stadium can be built using credit and then later the credit can be repaid by financial transaction detection logic 3 detecting when every ticket is sold for attending an event in stadium and the repayment logic 5 then charge a little extra for paying off the credit used to build the stadium.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

The system 1 of repaying credit can have other useful features and abilities. The system 1 can include a transmitter 12 that can be used to send messages. For example, the transmitter 12 could be used to send a message to the financer or creditor of the handheld device 10 indicating that a partial repayment of the handheld device 10 has been made. The transmitter can transmit the message to a network 14. The network 14 may be a wireless network and the transmitter can send the message to cellular antenna 16 in the wireless network. In some configurations, rather than send a message every time a partial payment is made the repayment logic 5 and the transmitter 12 can wait a periodic time before sending a message indicating how much was repaid during that period of time. For example, the repayment logic 5 and the transmitter 12 might send monthly reports on how much of the financing/credit has been repaid.

In some configurations, the preferred embodiment of the system 1 can include a database 18. The database 18 can be hardwired or wirelessly attached to the network 14 and can be located at the premise of the financer or creditor of the purchased item associated with the financial transaction detection logic 3 and the repayment logic 5. The database 18 can be used to keep track of the amount that is still owed. For example, when the purchase item is first purchased the database 18 can be loaded with a total value of credit that was used to purchase the purchased item. Later when financial transactions are performed at the purchased item they can be transmitted to the database and the amounts of repayment can be subtracted from the total value in the database 18. Eventually, the purchased item will be fully paid for when the value in the database reaches zero. When that happens, the database 18 can generate a message that is sent back to the financial transaction detection logic 3 and the repayment logic 5 to indicate that no further repayments are required.

The system 1 of repaying for an item each time a transaction occurs at it can also include a display. The display can provide indications of how much is being repaid at a particular transaction, how much is left to be repaid and/or other information. The display can be located at the purchased item, at the financer's or creditor's facility or another location.

The financial transaction detection logic 3 and the repayment logic 5 can be used with a purchased item that was purchased with credit or financing from one person or institution or they can be used with a purchased item that was purchased with credit or financing from several persons or institutions. For example, when used with a purchased item that was purchased with credit or financing from several persons or institutions the financial transaction detection logic 3 and the repayment logic 5 could make partial repayments to each person or institution at the time of a financial transaction or it could repay one of the persons or institutions at each financial transaction on a round robin basis until each person or institution was fully repaid.

The preferred embodiment has been described as making a repayment at each financial transaction, but in other embodiments it could only make a repayment at predetermined transactions. For example, the repayment logic 5 might be configured to make a partial repayment every fifth transaction. Of course, the repayments can be made based on financial transactions at the purchased item in other ways.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

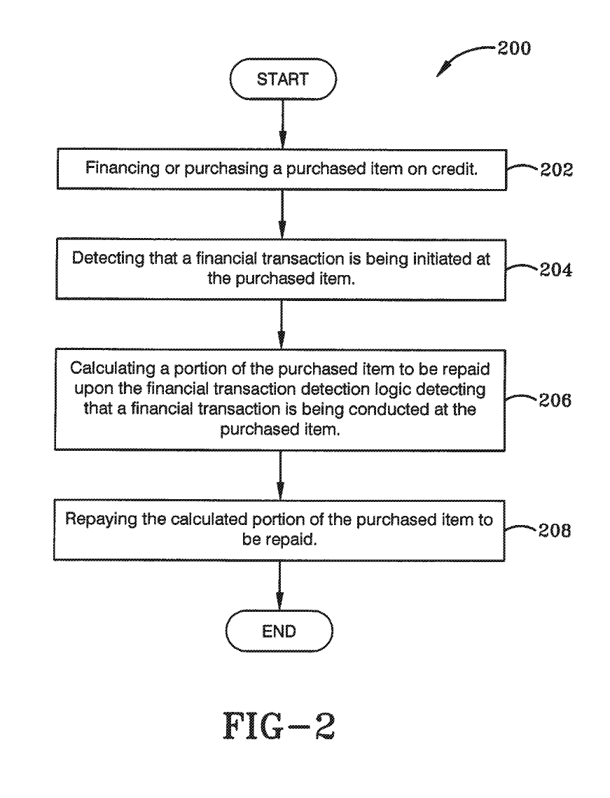

FIG. 2 illustrates a method 200 of repaying credit used to purchase a purchased item. The method 200 begins by financing or purchasing a purchased item on credit, at 202. Next, a financial transaction that is being initiated at the purchased item is detected, at 204. As discussed above, the transaction may be a person paying a fare at bus that was purchased with credit or the transaction can be connecting to a network with a handheld device that was purchased with credit or the purchasing of something else using the handheld device. A portion of the purchased item to be repaid is calculated, at 206, upon the financial transaction detection logic detecting that a financial transaction is being conducted at the purchased item. A percentage of the financial transaction can be used to determine the repayment amount of the purchase item.

The calculated repayment portion of the purchased item is repaid, at 208. The repaying can include the crediting a financial account with a payment and this can be done automatically over a network that can be at least partly a wireless network. The method 200 can transmit a message indicating a portion of the purchased item has been repaid to a creditor, financial institution or someone else interested in monitoring the continued payment of the purchased item. The method 200 can also keep a running tabulation amount that is a total amount that has been repaid on the purchased item. When this tabulation amount is the same as the purchase credit or financing value used to purchase the purchased item it has been repaid. The method 200 will then discontinue repaying a portion of the purchased item when the purchased item has been repaid.

The method 200 can be used when credit is extended from two or more entities to purchase the purchased item. In this case, the repaying a portion of the purchased item includes at the time of transaction at the purchased item repaying a portion of the purchased item to each of the financing entities. Alternatively the method 200 can alternate payments to each of the financing entities in a round-robin fashion after each financial transaction at the purchased item. The method 200 can also generate a receipt that a payment has been made and or it can send a message to a display associated with individual(s) or entity(s) interested in monitoring the continued payment of the purchased item.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

1. A method of repaying credit used to finance a purchase of a purchased item comprising:
a first processor for detecting that a financial transaction is being initiated at the purchased item;
a second processor for calculating a portion of the purchased item to be repaid upon detecting that a financial transaction is being conducted at the purchased item; and
automatically repaying the calculated portion of the purchased item to be repaid responsive to the detecting that a financial transaction is being initiated at the purchased item.

2. The method of repaying credit used to finance a purchase of a purchased item of claim 1 further comprising:
transmitting a message indicating a portion of the purchased item has been repaid.

3. The method of repaying credit used to finance a purchase of a purchased item of claim 1 wherein the repaying further comprises:
crediting a financial account with a payment for a portion of the purchased item.

4. The method of repaying credit used to finance a purchase of a purchased item of claim 1 wherein the detecting that a financial transaction further comprises:
detecting that the purchased item is being used to make a second purchase.

5. The method of repaying credit used to finance a purchase of a purchased item of claim 4 wherein the calculating a portion of the purchased item to be repaid further comprises:
calculating a portion of the purchased item to be repaid based, at least in part, on a total amount value of the second purchase.

6. The method of repaying credit used to finance a purchase of a purchased item of claim 4 wherein the calculating a portion of the purchased item to be repaid further comprises:
calculating a portion of the purchased item to be repaid based, at least in part, on a percentage amount of the second purchase.

7. The method of repaying credit used to finance a purchase of a purchased item of claim 4 further comprising:
detecting the second purchase is being made over a communications network.

8. The method of repaying credit used to finance a purchase of a purchased item of claim 4 further comprising:
detecting the second purchase is being made over a wireless communications network.

9. The method of repaying credit used to finance a purchase of a purchased item of claim 1 further comprising:
financing with two or more financing entities the purchase of the purchased item; and wherein the repaying a portion of the purchased item further comprises:
repaying a portion of the purchased item to each of the two or more financing entities.

10. The method of repaying credit used to finance a purchase of a purchased item of claim 1 further comprising:
tabulating a total amount that has been repaid on the purchased item that indicates when the purchased item is repaid; and
discontinuing repaying a portion of the purchased item when the purchased item has been repaid.

11. The method of repaying credit used to finance a purchase of a purchased item of claim 1 further comprising:
periodically generating a receipt for one or more financers of the purchased item indicating how much of the purchased item has been repaid.

12. The method of repaying credit used to finance a purchase of a purchased item of claim 1 wherein the purchased item is a vehicle and wherein the repaying further comprises:
repaying a portion of the purchased item each time a fare is collected from a passenger transported on the vehicle.

13. The method of repaying credit used to finance a purchase of a purchased item of claim 1 wherein the purchased item is a handheld device connectable to a communications network and wherein the repaying a portion of the purchased item further comprises:
repaying a portion of the purchased item when a financial transaction is conducted with the handheld device over the communications network.

14. The method of repaying credit used to finance a purchase of a purchased item of claim 1 further comprising:
accumulating a calculated portion of the purchased item to be repaid over a period of time; and
periodically paying the accumulated calculated portion at the end of a period of time.

15. A system for payment of a purchased item that was purchased using credit comprising:
a processor;
financial transaction detection logic configured to detect that a financial transaction is being initiated at the purchased item; and
repayment logic configured to repay a portion of the purchased item upon the financial transaction detection logic detecting that a financial transaction is being conducted at the purchased item.

16. The system for payment of a purchased item that was purchased using credit of claim 15 further comprising:
a transmitter configured to transmit data associated with the portion of the purchase item that is to be repaid.

17. The system for payment of a purchased item that was purchased using credit of claim 15 wherein the purchased item is a vehicle, wherein the financial transaction detection logic detects when a fare is collected for transportation by the vehicle, and wherein the repayment logic is configured to repay a portion of the purchased item based, at least in part, on the fare collected.

18. The system for payment of a purchased item that was purchased using credit of claim 15 further comprising:
a display for displaying information regarding a portion of the purchased item that was repaid.

19. The system for payment of a purchased item that was purchased using credit of claim 15 wherein the financial transaction detection logic and the repayment logic are located in a handheld device.

20. The system for payment of a purchased item that was purchased using credit of claim 19 wherein the financial transaction detection logic is configured to detect that a purchase for a consumer item is being initiated at the handheld device, and wherein the repayment logic is configured to repay a portion of the purchased item based, at least in part, on a cost of the consumer item.
